(19) United States
(12) Patent Application Publication
(10) Pub. No.: US 2009/0164203 A1
(43) Pub. Date: Jun. 25, 2009

(54) Non-volatile memory compiler

(75) Inventor: Robert Norman, Pendleton, OR (US)

Correspondence Address: UNITY SEMICONDUCTOR CORPORATION, 255 SANTA ANA COURT, SUNNYVALE, CA, 94085-4511, US

(73) Assignee: UNITY SEMICONDUCTOR CORPORATION, Sunnyvale, CA (US)

(21) Appl. No.: 12/004,740

(22) Filed: Dec. 23, 2007

(51) Int. Cl. G06F 9/455; G06F 12/00

(52) U.S. Cl. 703/24; 711/114; 711/E12.001

(57) ABSTRACT

A non-volatile memory compiler for non-volatile memory is disclosed. The non-volatile memory complier may include an input module and a builder module. The input module may accept memory parameters and the builder module may use the inputted memory parameters and its knowledge of the memory to design memory builds. The memory builds may include two-terminal non-volatile memory cells, multiple non-volatile memory layers, a logic plane positioned under one or more non-volatile memory layers, one or more non-volatile memory layers that are partitioned into sub-planes, one or more non-volatile memory layers that emulate one or more memory types such as SRAM, DRAM, ROM, or FLASH, and vertically stacked memory layers. FLASH memory may be emulated without the need to perform an erase operation as part of a write operation. The memory builds can include vias operative to electrically connect one or more non-volatile memory layers with circuitry in a logic plane.

### FIELD OF THE INVENTION

The present invention relates to semiconductors. More specifically, a non-volatile memory compiler is discussed.

### BACKGROUND

Memory components can be generated by a memory compiler that comes with a purchased technology library. A technical library is a collection of design behavior models at specific points in the design process. Example libraries (i.e., points in the design process) include low-level physical design, high-level physical design, high-level soft design, system design and implementation, and system architecture. Memory components are usually generated at the low-level physical design phase.

Memory compilers were developed to support the needs of the “System on a Chip” design capabilities that emerged with high density chip capabilities. Application Specific Integrated Circuit (ASIC) vendors, in an effort to support their customers needs, developed memory compilers to assist in the development of the system on a Chip designs.

Although static random access memory (SRAM), and read only memory (ROM) have different memory units and surrounding logic, their compilation techniques are similar. For example, a ROM compiler creates designs based on fixed data patterns through a metal mask design specifically adapted to be designed by a compiler. Typically, the designer enters inputs into the compiler. The inputs can include capacity, and bit width, along with other parameters including speed and power requirements. The designer initiates the compile operation. The compiler adds the addresses and bits to meet the entered requirements including developing the address decoders and drivers for the developed array. The driver is typically generated based on the speed and power requirements as is the transistor size. The ROM memory array is automatically generated from the data file provided by the customer. The data file includes the bit pattern for the software intended to execute from the ROM. The compiler takes this bit pattern and generates the metal connections, bit line driver sizes, and address line sizes required for the ROM to function properly with the provided software. Similarly, SRAM compilers are made to generate a memory array based on capacity and bit width. The transistors for the drivers are sized to meet the speed and power inputs. The memory array is generated from the input capacity and bit width.

Dynamic access memory (DRAM) and FLASH memory, however, include components that do not lend themselves to automated compilation. The capacitive array of DRAM is difficult to design in an automated fashion due to the refresh operation. The capacitive array and tight timing requirements of the refresh cycle of DRAM have resulted in no compilation support. FLASH memory uses high voltage gates and pumps, erase cycles, and state machines which are difficult to produce in an automated fashion. These devices are typically handcrafted to meet the specific requirements in a design.

DRAM is used in designs because of its inexpensiveness. However, DRAM may be available in fixed block designs that may come in limited sizes. The few available sizes may not be a close match for the design, so a larger size than needed may be selected, wasting die space and causing inefficiencies. The design inefficiently accommodates the larger than needed DRAM chip and connects to it at specific 10 points. The designer may design around the DRAM chip.

FLASH memory is used for its flexibility. That is for its lack of need for a battery and its retention of data through power loss. However, users may choose to hand craft FLASH memory for system on a chip applications, choose between limited FLASH capabilities in the ASIC environment, or choose to place the FLASH memory outside the ASIC.

There are continuing efforts to improve memory compilers.

### BRIEF DESCRIPTION OF THE DRAWINGS

The present invention will be readily understood by the following detailed description in conjunction with the accompanying drawings, and like reference numerals designate like structural elements. Although the Drawings depict various examples of the invention, the invention is not limited by the depicted examples. Furthermore, the depictions are not necessarily to scale.

FIG. 1 illustrates a non-volatile memory compiler;

FIG. 2 illustrates an ASIC memory design;

FIG. 3 illustrates stacked non-volatile memory;

FIG. 4A illustrates the top down view of a non-volatile compiled stacked memory design;

FIG. 4B illustrates the right side view of the non-volatile compiled stacked memory design;

FIG. 5A illustrates a single non-volatile memory plane;

FIG. 5B illustrates stacked planes of non-volatile memory;

FIG. 5C illustrates a cross sectional view of stacked non-volatile memory;

FIG. 5D illustrates a cross sectional view of stacked planes of non-volatile memory with insulators;

FIG. 5E illustrates a stacked memory array divided into sub-planes

FIG. 6 illustrates via connection of the stacked non-volatile memory;

FIG. 7 illustrates a non-volatile compiled memory block;

FIG. 8 illustrates a stacked non-volatile compiled memory block;

FIG. 9A illustrates a top view of a cache and processor underneath a non-volatile memory array;

FIG. 9B illustrates a bottom side view of a cache and processor underneath a non-volatile memory array; and

FIG. 9C illustrates a right side view of a cache and processor underneath a non-volatile memory array.

### DETAILED DESCRIPTION

The invention may be implemented in numerous ways, including as a system, a process, an apparatus, or as computer program instructions included on a computer readable medium such as a computer readable storage medium or a computer network wherein program instructions are sent over optical or electronic communication links.

A detailed description of one or more examples is provided below along with accompanying figures. The detailed description is provided in connection with such examples, but is not limited to any particular embodiment. The scope is limited only by the claims, and numerous alternatives, modifications, and equivalents are encompassed. Numerous specific details are set forth in the following description in order to provide a thorough understanding. These details are provided for the purpose of example and the described embodiments may be implemented according to the claims without some or all of these specific details. For the purpose of clarity, technical material that is known in the technical fields related to the embodiments has not been described in detail to avoid unnecessarily obscuring the description.

Non-volatile memory technologies may be used with memory systems to develop high density, low cost, and fast access memories. Access may refer to accessing and performing data operations (e.g., read, write, erase) on a memory or memory array. The memory array may provide vertically-configured cell arrays (e.g., vertically-stacked, cross-point, two- or three-terminal, non-volatile memory arrays). Advantages to vertically-stacked arrays include reduced die size and manufacturing costs and system-level functionality. Greater reductions in die size can be realized with two-terminal cross-point non-volatile memory arrays because areal density increases due to fewer routing resources required to route interconnect for two-terminal devices when compared to three-terminal non-volatile memory arrays, which require additional routing resources for the three-terminals that result in a decrease in areal density. An exemplary non-volatile memory technology is disclosed in U.S. patent application Ser. No. 11/095,026, filed Mar. 30, 2005, and titled “Memory Using Mixed Valence Conductive Oxides,” hereby incorporated by reference in its entirety and for all purposes, describes two terminal memory cells that can be arranged in a cross-point array. The application describes a two terminal memory element that changes conductivity when exposed to an appropriate voltage drop across the two terminals. Multiple layers of the cross-point arrays may be vertically stacked upon one another to form the aforementioned vertically stacked array configuration. The memory element includes an electrolytic tunnel barrier and a mixed valence conductive oxide. The voltage drop across the electrolytic tunnel barrier causes an electrical field within the mixed valence conductive oxide that is strong enough to move oxygen ions out of the mixed valence conductive oxides and into the electrolytic tunnel barrier. Oxygen depletion causes the mixed valence conductive oxide to change its valence, which causes a change in conductivity. Both the electrolytic tunnel barrier and the mixed valence conductive oxide do not need to operate in a silicon substrate, and, therefore, can be fabricated above circuitry being used for other purposes (e.g., such as selection circuitry).

The two-terminal memory elements can be arranged in a cross point array such that one terminal is electrically coupled with an x-direction line and the other terminal is electrically coupled with a y-direction line. A stacked cross point array consists of multiple cross point arrays vertically stacked upon one another, sometimes sharing x-direction and y-direction lines between layers, and sometimes having isolated lines. When a first write voltage V_{W1} is applied across the memory element, (typically by applying ½ V_{W1} to the x-direction line and ½ -V_{W1} to the y-direction line) it switches to a low resistive state. When a second write voltage V_{W2} is applied across the memory element, (typically by applying ½ V_{W2} to the x-direction line and ½-V_{W2} to the y-direction line) it switches to a high resistive state. Typically, memory elements using electrolytic tunnel barriers and mixed valence conductive oxides require V_{W1} to be opposite in polarity from V_{W2}.

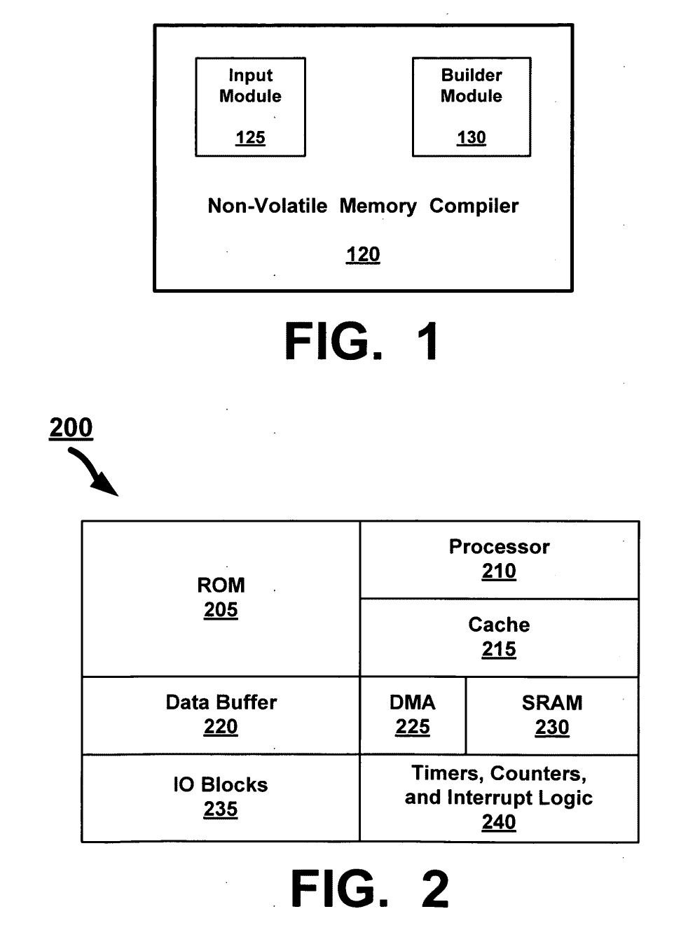

FIG. 1 illustrates a non-volatile memory compiler 120. In some embodiments, non-volatile compiler 120 includes an input module 125 and a builder module 130. Input module 125 may accept memory parameters. Memory parameters may be referred to as design inputs, inputs, parameters, constraints, layout details, layout parameters, layout constraints, build parameters, build inputs, any combination of the terms, or similar terms. Memory parameters may include but is not limited to one or more of area, aspect ratio, capacity, speed, number of memory array layers, emulation types, and other memory cell block characteristics. Area may be the area of the chip that the memory may consume. In some embodiments, the area may be the remaining space on an ASIC after other components have been selected. In some embodiments, the area may be a pre-selected die space on an ASIC. Similarly, the aspect ratio may be the ratio of the length of the space that the memory may consume to the width of the space that the memory may consume. In some embodiments, the length and width are similar such that the aspect ratio approaches 1. Capacity may be the quantity of memory desired. An example capacity parameter may be 1 kilobyte of memory. Speed may be the access rates or the read and write rates for the memory. The number of memory array layers may be the number of layers of memory arrays in the finished memory build. Emulation types may be the type of memory that may be emulated. For example, the memory build may include static random access memory (SRAM) emulation, dynamic random access (DRAM) emulation, read only memory (ROM) emulation, FLASH memory emulation, data buffer emulation, or a combination of them. In some embodiments, emulation may include the ability to communicate with the memory interfaces of that emulation. The compiler will include a library of interface modules that duplicate the memory interface that is being requested, such as SRAM or DRAM. For example, the FLASH memory emulation may be able to accept an erase command from a Flash driver, and the DRAM memory emulation may be able to accept a refresh command from a DRAM driver although neither is necessary. That is, when utilizing the two-terminal stackable non-volatile memory, the non-volatile memory functions preserve data through a power loss but also have the ability to emulate other memory types and the ability to perform consecutive writes (i.e., no erase cycle is required). For example, if a Flash driver sent an erase command to the two-terminal stackable memory, the memory logic may respond that the erase command is complete even though no erase was done or required, or alternatively the memory interface may do an all zeroes write to the selected block which may emulate the results of a Flash device. The option of which type of erase emulation to support may be a compiler option. This interaction allows the Flash Interface to be used with two-terminal stacked non-volatile memory.

Builder module 130 may use the inputted memory parameters and its knowledge of the memory to design memory builds. Knowledge of the memory design characteristics may include but is not limited to cell size, shape, power needs, number of terminals, terminal site, speed, impact of combining cells together, impact of same size memory blocks vs. differing size memory blocks, impact of number of address lines, impact of using full or partial address decoding, impact of stacking, impact of using shared or dedicated address decoding, impact of via quantity and placement, impact of various memory emulations, and other issues that may effect resultant memory build characteristics.

Knowledge of the cell size may include dimensions of the memory cell, or an area. Knowledge of shape may include an aspect ratio or polygon shape that may accommodate the memory cell. Knowledge of power needs may include the power needs for one cell, for an array of memory cells, for layers of arrays of memory cells, and how to minimize power consumption. Knowledge of number of terminals may include the number of terminals possessed by one or more versions of the memory cell. Knowledge of terminal site may include the physical location or position of the terminals on the memory cell. Knowledge of speed may include accessing speeds for one cell, for an array of cells, for layers of arrays of memory cells, and how to maximize speed. For example, speed may be increased by having dedicated Y decoders, however this impacts cost. Knowledge of impact of combining cells together may include latency information, power consumption characteristics, heat dissipation and other circuit characteristics. Knowledge of impact of same size memory blocks vs. differing size memory blocks may include the effect of having differing size memory cells in the same design. Knowledge of impact of number of address lines may include understanding how access speed and memory block size/shape may be affected by manipulating the number of address lines. Knowledge of impact of using full or partial address decoding may include the trade off between size and speed. Knowledge of impact of stacking may include the builder module being able to configure memory in three-dimensions. That is, the compiler may be programmed with the ability to stack single memory array layers and create a three-dimensional memory array. This awareness may be referred to as a being a three-dimensional memory compiler and may influence all areas of design as the stacking may have an effect on decoding, addressing, capacity, via placement, and also have an effect on size, speed, power consumption, etc. Knowledge of impact of using shared or dedicated address decoding may include determining if sharing addressing will save enough logic space to warrant the complexity. The knowledge of using shared addressing maybe referred to as plane share. Knowledge of impact of via quantity and placement may include determining the number of vias and the most symmetrical placement of the vias to optimize access to the layers of memory blocks, emulation area, addressing partitions, etc. Knowledge of impact of various memory emulations may include trade offs on location of the emulation, addition of drivers in the memory logic, and that impact on speed. The knowledge of the design characteristics may be stored in builder module 130 in the form of one or more algorithms look up tables, or similar programming constructs. The impact of design choices may affect power consumption, size, speed, and other memory characteristics.

Designing memory builds may be referred to as configuring memory, creating a memory layout, compiling memory, laying out memory, arranging memory, coordinating memory, assembling memory, or the like. In some embodiments, the memory parameters input into the compiler may include one or two values. In this case, builder module 130 may provide several memory builds that meet the inputted parameters to choose from. These memory builds may have differing characteristics. For example, if the input parameters include speed and capacity, memory builder module 130 may create a first build with a single layer memory array that is faster, consumes less power, but has a larger die space, a second build with a several layer memory array that may be slightly slower, consumes more power, but has smaller die space, and a third build with a slightly larger die space and fewer layers than the second build, that is slightly faster than the second build but slower and consuming less space than the first build. A designer may choose the build that best meets the needs of the circuit being built. In some embodiments, builder module 130 may provide the characteristics of each memory build.

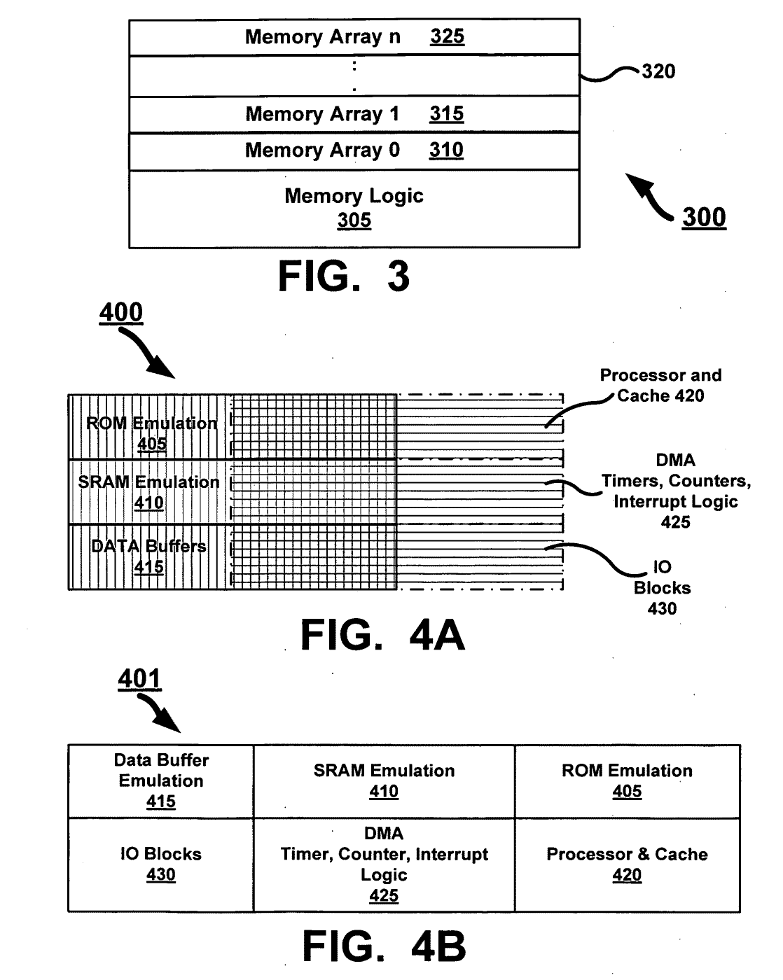

FIG. 2 illustrates an ASIC memory design 200. In some embodiments, a ASIC memory design 200 may be build by an SRAM compiler and may include ROM 205, processor 210, cache 215, data buffers 220, direct memory addressing (DMA) 225, SRAM 230, 10 Blocks 235, and timers, counters, and interrupt logic 240. ROM 205 may include the instructions for the ASIC 200. Processor 210 may execute the instructions in ROM 205. Cache 215 may be used during processing to store operating data. Data buffer 220 may be used to store data. DMA 225 may be used to perform direct memory addressing to SRAM 230. SRAM 230 may be used to store data. 10 blocks 235 may be used for output data. The timers, counters, and interrupt logic may be used to control the ASIC 200. This example of the ASIC 200 may cover a large die space as each component may be positioned in a single layer. However, the stacked memory shown in FIG. 3 may offer an improved solution.

FIG. 3 illustrates stacked non-volatile memory 300. In some embodiments, stacked non-volatile memory 300 may be created by builder module 130 and may include memory logic 305, and memory arrays 0 through n (elements 310 through 325). Memory logic 305 may be positioned on the bottom, or underneath the memory array layers 0 through n (elements 310-325). In some embodiments, several layers of memory arrays may be included in stacked non-volatile memory 300. In some embodiments, one layer of memory array may be included in stacked non-volatile memory 300. This stacked memory array approach may reduce the die size of a created ASIC such as shown in FIG. 4A.

FIG. 4A illustrates the top down view 400 of a non-volatile compiled stacked memory design. In some embodiments, compiled memory stack 400 may include ROM emulation 405, SRAM emulation 410, data buffers 415, processor and cache 420, DMA, timers, counters, and interrupt logic 425, and 10 blocks 430 similar to the components in ASIC memory design 200 depicted in FIG. 2. Here, however, ROM emulation 405, SRAM emulation 410, data buffers 415 may be included in one layer illustrated with the vertical hash marks, while processor and cache 420, DMA, timers, counters and interrupt logic 425, and 10 blocks 430 may be included in another layer illustrated by the horizontal hash marks. That is, processor and cache 420 may be positioned in one layer underneath a second layer including ROM emulation 405; DMA, timers, counters, and interrupt logic 425 may be positioned in one layer underneath a second layer including SRAM emulation 410; and 10 blocks 430 may be positioned in one layer underneath a second layer including data buffers 415. Thus, the die space may be reduced in the non-volatile stacked memory design 400 even though functionality similar to the ASIC memory design 200 may be included. FIG. 4A is shown with the layers skewed to demonstrate the layering; however, the layers may be positioned directly above each other.

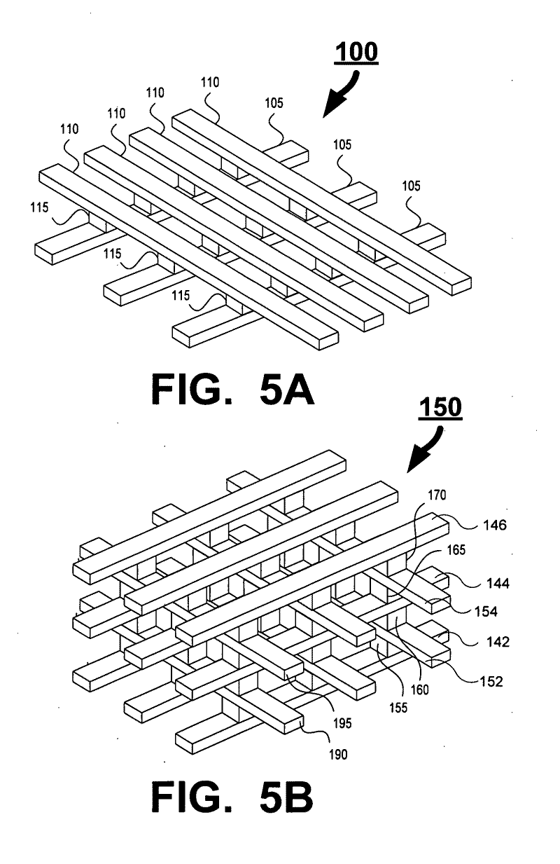

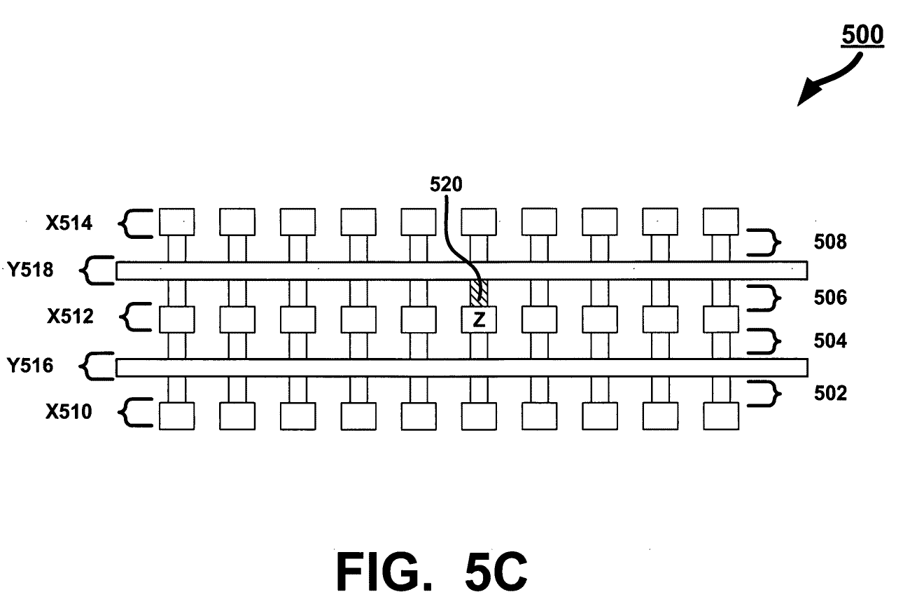

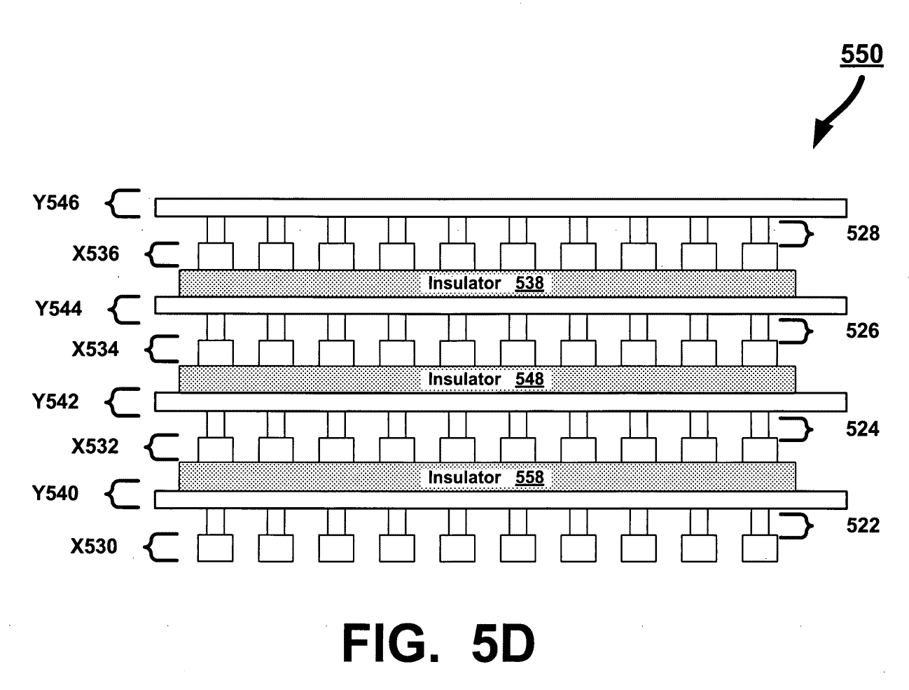

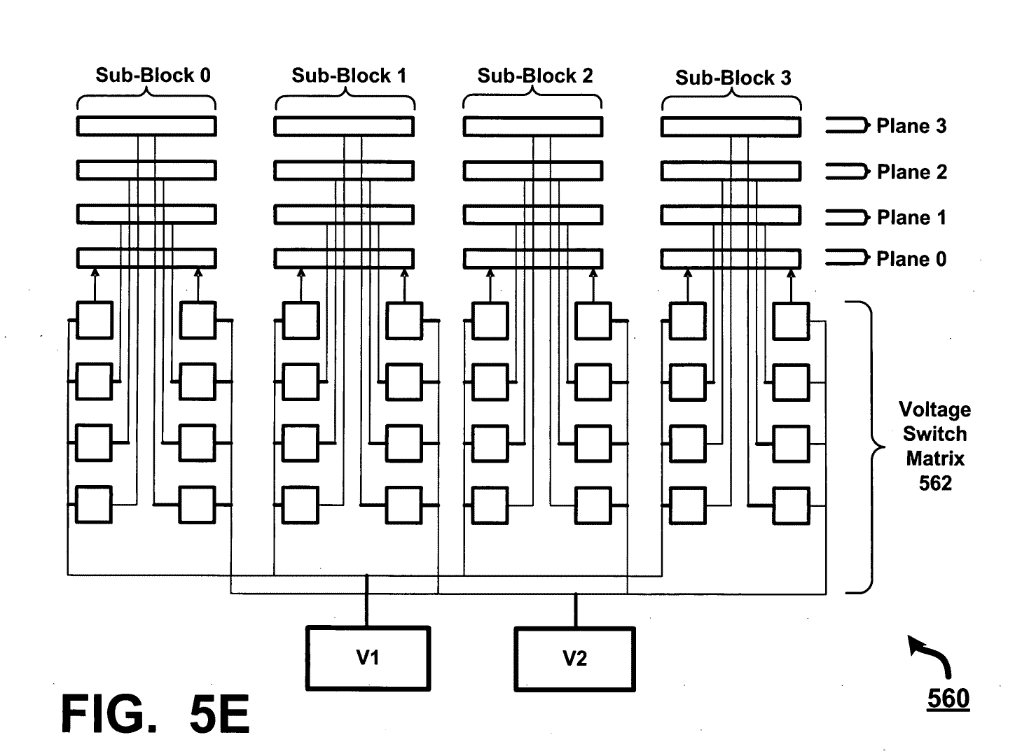

FIG. 4B illustrates the right side view 401 of the non-volatile compiled stacked memory design. In one embodiment, stacked memory design 400 may include 2 layers which may be more evident in the right side view. The bottom layer may include processor and cache 420, DMA timer, counter, and interrupt logic 425, and 10 blocks 430. The top layer may include ROM emulation 405, SRAM emulation 410, and data buffer emulation 415. ROM emulation 405 may be positioned above processor and cache 420. SRAM emulation 410 may be positioned above DMA, timers, counters, and interrupt logic 425. Data buffer emulation 415 may be positioned above 10 blocks 430. In other embodiments, other layering combinations may occur. As mentioned above, the layering provides for a smaller die space for the memory design. In some embodiments, the memory emulations may be arranged in sub partitions or sub-planes. That is, the memory array layers may be divided or partitioned to allocate different partitions to different memory emulations. This partitioning may be referred to as creating sub-planes and is further explained in reference to FIG. 5E.

FIG. 5A illustrates a single non-volatile memory plane 100. In some embodiments, single non-volatile memory plane 100 may be designed by non-volatile memory complier 120 and may include a layer of memory blocks 115, sandwiched between two layers of multiple parallel metal strips 105 and 110. The first layer of multiple parallel metal strips 105 may be positioned in a perpendicular fashion to the second layer of parallel metal strips 110. Each memory block in the layer of non-volatile memory blocks may be positioned at an intersection point of the first layer of parallel metal strips 105 and the second layer of parallel metal strips 110. To access the memory blocks the first layer of multiple parallel metal strips may correspond to the bit line; the second layer of multiple parallel metal strips may correspond to the word line.

FIG. 5B illustrates stacked planes of non-volatile memory 150. In some embodiments, stacked planes of non-volatile memory 150 may be designed by non-volatile memory compiler 120, and may include a plurality of layers of metal strips and a plurality of layers of memory blocks. Each layer of metal strips may include a plurality of metal strips positioned in a single plane in parallel. Here, three parallel metal strips are shown in each of five layers; however, this is just an illustration and not meant to limit scope. Each layer of memory blocks may be sandwiched between two layers of metal strips. The metal strips may be used to select a memory block for access. Access may include reading and writing. Writing may include switching or changing the logic state of the memory block. For example, to select memory block 170, metal strips 146 and 154 may be used. To select memory block 165, metal strips 154 and 144 may be used. To select memory block 160, metal strips 144 and 152 may be used. To select memory block 155, metal strips 142 and 152 may be used. Selection of a memory block may involve utilizing one metal strip as the word line and the perpendicular metal strip as the bit line. For example, to switch memory block 155, between logic 0 and logic 1, metal strip 142 may be used at the bit line and metal strip 152 may be used as the word line. Selection may involve placing a high signal on the metal strips such that the intersection of the high signals may identify the memory block it is desired to access. In some embodiments, to create one logic state the word line may have a voltage applied and the bit line may be grounded. The alternate logic state may be produced by placing a negative voltage, equal in amplitude to the positive voltage, on the word line and holding the bit line at ground. In some embodiments, a positive voltage and ground may be used to cause the switch in logic states. In some embodiments, a positive voltage and an equal in amplitude negative voltage may be used to cause the switch in logic states.

FIG. 5C illustrates a cross sectional view of stacked non-volatile memory 500. In some embodiments, stacked non-volatile memory may include layers of memory blocks 502-508, layers of word lines X510-X514, and layers bit lines Y516-Y518. Bit lines Y516 and Y518 may be positioned in parallel to each other. Word lines X510 through X514 may be interleaved and positioned in parallel to each other. The word lines and the bit lines may be positioned perpendicular to each other. Memory block layers 502 through 508 may be sandwiched between the word lines and the bit lines. In some embodiments, to change the logic state of memory block 520 in memory layer 506 bit line Y518 may be held at ground and Word line Z in word layer X512 may be held at +6 volts. In some embodiments, to reverse the state of memory block 520 bit line Y518 may be held at ground while a −6 volts may be applied to word line Z. When the bit lines and word lines have voltage applied there is the potential for memory disturb effects.

Memory disturb occurs when the voltage used to make a logic switch for one memory block affects memory blocks other than the one intended. As a memory performs a write operation, the bit line voltages may cross the unselected word lines. Voltage crossing the unselected word lines may cause coupling or connecting, producing a small voltage and current that may affect the memory block on those lines. The unselected word lines may be grounded, but still may act as transmission lines causing coupling. Over time the coupling may disturb the memory blocks causing degradation and bit flipping, producing errors. For example, in FIG. 5C selection of memory block 520 may cause disturb effects. If voltage differential is applied to word line Z in the X512 row and bit line Y518, then memory blocks in memory block 520 may switch logic states or be written. The voltages on Y518 may cause disturb effects on the other memory blocks in memory block layer 506. The memory blocks in memory block layer 508 may experience disturb effects as well since Y518 is also connected to those memory blocks. In other words, for any bit line, a disturb voltage may be induced in the memory elements attached both above and below. The larger the number of word lines traversed by a bit line, the greater the potential for disturb effects. In this example, word line Z may also induce disturb effects in the memory block below it in memory block layer 504. The compiler may take several approaches to reduce disturb effects. These approaches are illustrated in FIGS. 5D and 5E.

FIG. 5D illustrates a cross sectional view of stacked planes of non-volatile memory with insulators, 550. In some embodiments, a stacked plane of non-volatile memory built by a compiler includes memory block layers 522-528, word lines X530-X536, bit lines Y540-Y546, and insulator layers 538, 548, and 558. Insulators 538, 548, and 558, limit the contact of each bit line, each memory block layer having a separate bit line. Here, voltage on bit line Y544 affects memory block layer 526, not the layer above.

FIG. 5E illustrates a stacked memory array divided into sub-planes 560. In some embodiments, stacked memory built by a compiler may be divided into sub-planes including memory planes (Plane 0, Plane 1, Plane 2, and Plane 3), sub-array sub-blocks (Sub-Block 0, Sub-Block 1, Sub-Block 2, and Sub-Block 3), voltage switch matrices 562, and voltages V1 and V2. Partitioning the memory array layers into sub-arrays, partitions, or sub-blocks may be another approach to reducing disturb effects. Partitioning the memory array layers may be referred to as plane sharing or the compiler being configured to plane share. The partitioning of the memory array into sub arrays limits the amount of memory blocks or word lines traversed by a bit line. Reducing the number of word lines crossed by each bit line limits the possibility of disturb effect to the connected word lines. In some embodiments, partitioning the memory array layers may be used to meet speed requirements. In some embodiments, partitioning the memory array layers may be used to meet specific partitioning requirements.

In some embodiments, reducing the disturb effect may include reducing the slew rate of the applied voltages. Coupling may be determined by Cdv/dt, that is the faster the rise time of the voltage, the greater the disturb effect. Thus, slowing the rise time of the voltages applied to the word and bit lines may reduce the coupling or disturb effects. There are a number of circuits to reduce the slew rate of a voltage switch. These circuits may be included in a memory logic portion of the memory array.

Selection of the memory block and address location may include the use of an address decoder. An address decoder may be referred to as a circuit that converts an address to the electrical signals required to retrieve data from a memory cell or other storage device. In some embodiments, an address may be a plurality of bits or address lines. A portion of the bits or address lines (hereafter lines) of the address may be used to identify the memory block, the remaining portion of the address bits may be used to identify a location within the memory block. In some embodiments, non-volatile memory compiler 120 may design full address decoding. In full address decoding all the address lines may be used to indicate a memory block. Each memory location in full address decoding may be identifiable by one address. In some embodiments, non-volatile memory compiler 120 may design partial address decoding. In partial address decoding, a subset of the address lines may be used, as not all the address space is implemented. Each memory location, in partial address decoding, may be identified by more than one address.

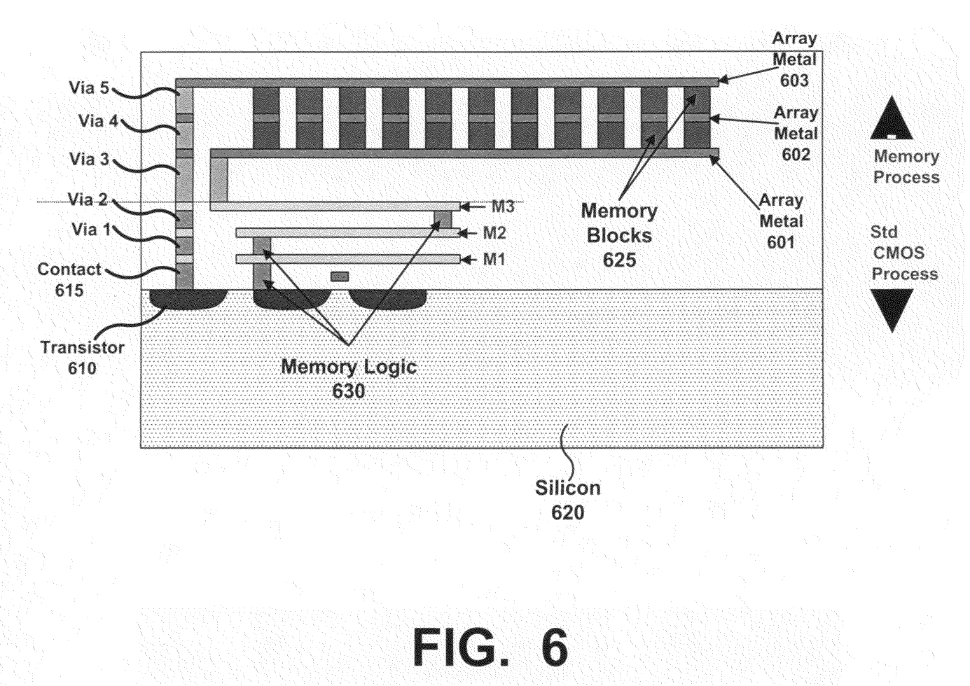

FIG. 6 illustrates via connection of the stacked non-volatile memory. FIG. 6 may be considered a physical interpretation of a stacked non-volatile memory that may be built by non-volatile memory compiler 120. Transistor 610 may be positioned in silicon 620. Metal layers M1 through M3 may be included during the standard Complementary Metal-Oxide Semiconductor (CMOS) processing for memory creation. Contact 615 and via 1 through via 5 may connect the layers of memory to silicon 620 and transistor 610. Non-volatile memory compiler 120 may position the vias in the periphery to the memory blocks to keep the memory planes contiguous and the vias symmetrical. The stacked non-volatile memory array may be represented by the layers of metal strips, array metal 601 through array metal 603, and the layers of memory blocks, memory blocks 625. Array metal 602 may include metal strips that are situated perpendicular to the metal strips included in array metal 601 and array metal 603. Here, eleven metal strips are shown in array metal 602; however, in some embodiments, non-volatile memory compiler 120 may design greater or fewer metal strips to be included in a stacked non-volatile memory array. Non-volatile memory compiler 120 may design memory logic 630 to be situated underneath the stacked non-volatile memory array, such that via 1 through via 5 provide connection between memory logic 630 and memory blocks 625. Here a two-layer memory stack is illustrated. In some embodiments, more or less than two layers may be implemented in a memory stack.

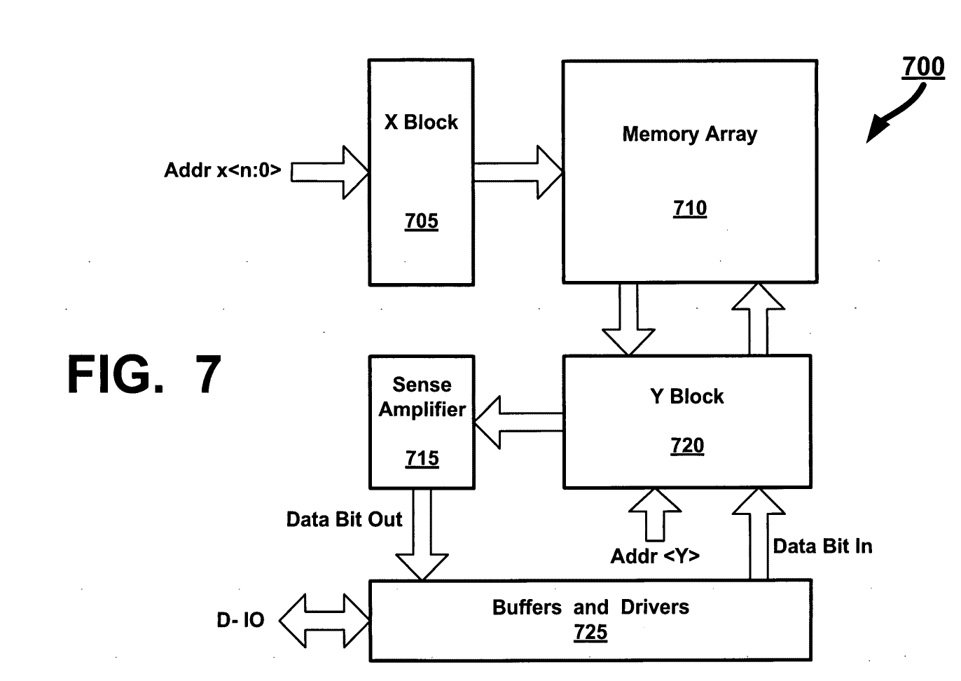

FIG. 7 illustrates a non-volatile compiled memory block 700. In some embodiments, a non-volatile compiled memory block compiled by non-volatile memory compiler 120 may include: X block 705, memory array 710, sense amplifier 715, Y block 720, and buffers and drivers 725. FIG. 7 may illustrate a single layer non-volatile compiled memory block such as that illustrated in FIG. 5A. An x address Addr x<n:0> may be input into X block 705 and a y address Addr <Y> may be input into Y block 720. An address may include a plurality of address lines or bits. The address lines or bits may include an enable line, a memory block address, and a memory cell address. X block 705 and Y block 720 may decode the x address and y address, respectively, into the respective electrical signals required to access a memory block and a location within the memory block in memory array 710. Upon accessing the correct memory cell location, Data Bit In may be stored in the memory block location or Data Bit Out may be retrieved from the memory block location. When retrieving data from a memory block location, sense amplifier 715 may sense the value of the data in the memory block location, may amplify the voltage, and may transfer the amplified value to buffers and drivers 725. In some embodiments, sense amplifier 715 may reduce latency in memory retrieval. Buffers and drivers 725 may act as a holding bin and an interface to other components so that the Data Bit In and Data Bit Out are held ready to be placed in storage or to be output and may be converted to a form that the other components can understand.

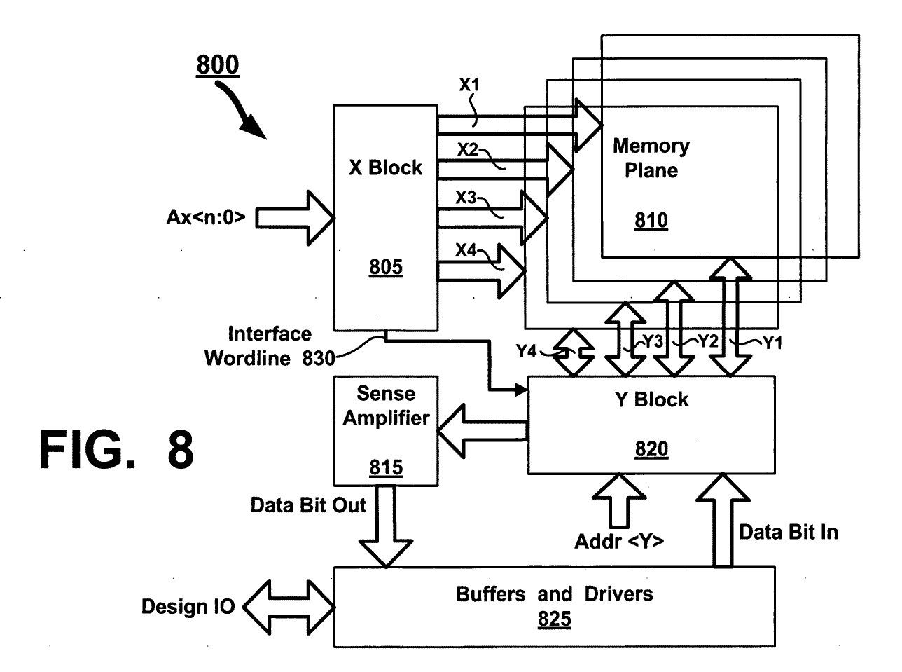

FIG. 8 illustrates a stacked non-volatile compiled memory block 800. In some embodiments, a stacked non-volatile compiled memory block compiled by non-volatile memory compiler 120 may include X block 805, memory plane 810, sense amplifier 815, Y block 820, vias X1 through X4, vias Y1 through Y4, and buffers and drivers 825. FIG. 8 may illustrate a stacked non-volatile compiled memory block such as that illustrated in FIG. 5B. Non-volatile memory compiler 120 may design memory plane 810 to include multiple layers of memory blocks. An x address Ax<n:0> may be input into X block 805 and a y address Addr <Y> may be input into Y block 820. Non-volatile memory compiler 120 may design an address to include a plurality of address lines or bits. The address lines or bits may include an enable line, a memory block address, and a memory cell address. The number of enable lines, memory block address lines and memory cell address lines may depend on the input parameters entered into non-volatile memory compiler 120. In some embodiments, the number of enable lines is based on the number of layers of memory blocks in the design of memory plane 810. X block 805 and Y block 820 may decode the x address Ax<n:0> and y address Addr <Y>, respectively, to identify a memory block and a location within memory plane 810. In some embodiments, the address lines may be shared among the memory plane layers. In one implementation, non-volatile memory compiler 120 may use a multiplexer to switch among the different memory block layers. In another embodiment, the enable lines may be used to switch among the memory block layers. In some embodiments, non-volatile memory compiler 120 may design a dedicated X block and a dedicated Y block to decode the addresses in memory plane 810. In some embodiments, the non-volatile memory compiler 120 may increase the Y block address lines to have the aspect ratio of the memory build approach 1. Upon decoding the address lines, vias X1 through X4 and Y1 through Y4 may be used to access the appropriate memory cell in memory plane 810. Upon accessing the correct memory cell location, Data Bit In may be stored in the memory block location or Data Bit Out may be retrieved from the memory block location. When retrieving data from a memory block location, sense amplifier 815 may sense the value of the data in the memory block location, may amplify the voltage, and may transfer the amplified value to buffers and drivers 825. In some embodiments, sense amplifier 815 may reduce latency in memory retrieval. Buffers and drivers 825 may act as a holding bin and an interface to other components so that the Data Bit In and Data Bit Out are held ready to be placed in storage or to be output and may be converted to a form that the other components can understand.

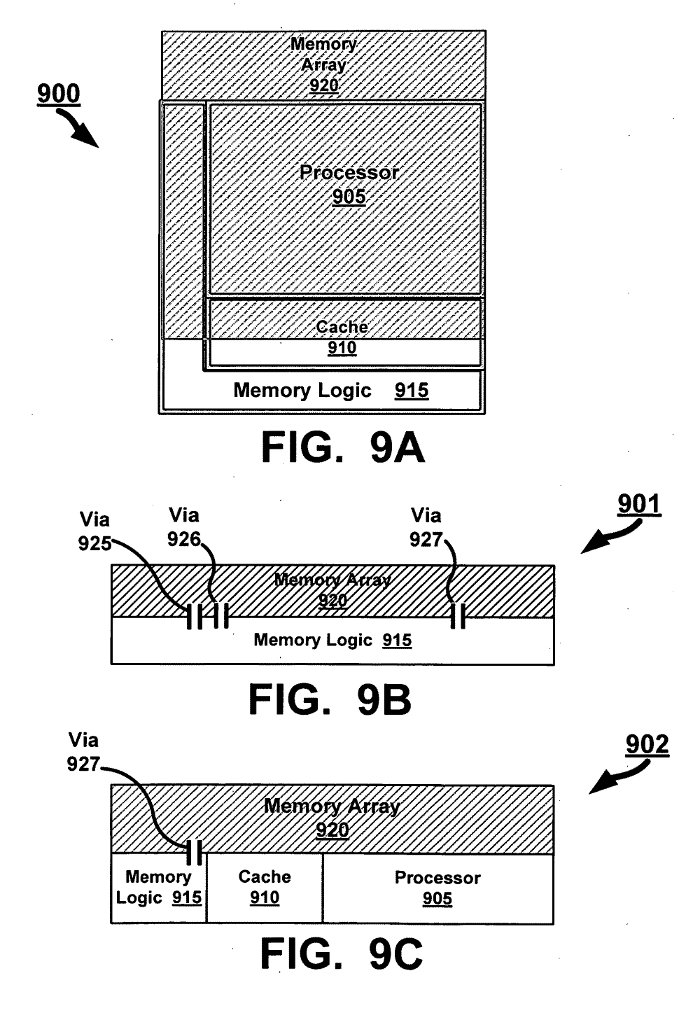

FIG. 9A illustrates a top view 900 of a cache and processor layer underneath a non-volatile memory array layer. In some embodiments, non-volatile memory compiler 120 designs a memory build to include processor 905, cache 910, memory logic 915, and memory array 920. In some embodiments, non-volatile memory compiler 120 may design memory logic 915, cache 910, and processor 905 to be located in a layer underneath memory array 920. Memory logic 915 may include the 10 blocks, DMA, timers, counters, interrupt logic, and vias. Non-volatile compiler 120 may design the memory logic 915 to be positioned along the left and bottom edges of the design to keep the memory contiguous and symmetrical. In some embodiments, the layout may be on the right and top depending on the overall IC layout.

FIG. 9B illustrates a bottom side view 901 of a cache and processor layer underneath a non-volatile memory array layer. In the bottom side view, non-volatile memory compiler 120 may design memory logic 915 to appear on the bottom layer and memory array 920 to appear on the top layer. Cache 910 and processor 905 may be located behind memory logic 915 in the bottom layer, but may not be visible from the bottom side view. Non-volatile memory compiler 120 may design Vias 925-927 to provide connection between memory logic 915 and memory array 920.

FIG. 9C illustrates a right side view 903 of a cache and processor layer underneath a non-volatile memory array layer. In the right side view, processor 905, cache 910 and memory logic 915 may appear in the bottom layer. Memory array 920 may appear in the top layer. Via 927 may be the viewable in the right side view.

With the above embodiments in mind, it should be understood that the invention may employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

The invention can also be embodied as computer readable code on a computer readable medium. The computer readable medium is any data storage device that can store data which can be thereafter read by a computer system. The computer readable medium also includes an electromagnetic carrier wave in which the computer code is embodied. Examples of the computer readable medium include hard drives, network attached storage (NAS), read-only memory, random-access memory, CD-ROMs, CD-Rs, CD-RWs, magnetic tapes, and other optical and non-optical data storage devices. The computer readable medium can also be distributed over a network coupled computer system so that the computer readable code is stored and executed in a distributed fashion.

Any of the operations described herein that form part of the invention are useful machine operations. The invention also relates to a device or an apparatus for performing these operations. The apparatus may be specially constructed for the required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The above described invention may be practiced with other computer system configurations including hand-held devices, microprocessor systems, microprocessor-based or programmable consumer electronics, minicomputers, mainframe computers and the like. Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims. In the claims, elements and/or steps do not imply any particular order of operation, unless explicitly stated in the claims.

What is claimed is:

1. A method of designing a non-volatile memory array, comprising:
receiving a plurality of parameters;
electronically compiling a plurality of memory builds based on the plurality of parameters, the memory builds including non-volatile memory; and
providing characteristics for the plurality of memory builds.

2. The method of claim 1, wherein the plurality of memory builds comprises two-terminal memory cells.

3. The method of claim 1, wherein at least one of the plurality of memory builds includes multiple memory layers.

4. The method of claim 1, wherein at least one of the plurality of memory builds includes a logic layer underneath one or more non-volatile memory layers, the logic layer configured to communicate with the one or more non-volatile memory layers.

5. The method of claim 4, wherein the electronically compiling further comprises partitioning the one or more non-volatile memory layers into one or more sub-planes, the one or more sub-planes including a portion of each non-volatile memory layer.

6. The method of claim 4, wherein at least one of the non-volatile memory layers emulates static random access memory (SRAM).

7. The method of claim 4, wherein at least one of the non-volatile memory layers emulates read only memory (ROM).

8. The method of claim 4, wherein at least one of the non-volatile memory layers emulates dynamic random access memory (DRAM).

9. The method of claim 1, wherein the providing characteristics for the plurality of memory builds further comprises providing characteristics for a single layer memory build and a multiple-layer memory build.

10. The method of claim 1, wherein the electronically compiling the plurality of memory builds includes compiling shared decoders.

11. The method of claim 1, wherein the electronically compiling the plurality of memory builds includes compiling dedicated decoders.

12. The method of claim 1, wherein the plurality of parameters includes aspect ratio.

13. The method of claim 1, wherein the plurality of parameters includes number of memory array layers.

14. The method of claim 1, wherein the plurality of parameters includes memory emulation.

15. A non-volatile memory compiler, comprising:
an input module configured to accept design inputs; and
a builder module configured to layout one or more memory builds based on the design inputs, the memory builds including one or more non-volatile memory arrays.

16. The non-volatile memory compiler of claim 15 and further comprising:
an emulation module configured to layout one or more portions of the one or more memory builds and to emulate based on the design inputs, one or more memory types selected from the group consisting of static random access memory (SRAM), dynamic random access memory (DRAM), and read only memory (ROM).

17. The non-volatile memory compiler of claim 15, wherein the builder module is further configured to layout one or more memory builds including multiple memory layers.

18. The non-volatile memory compiler of claim 17, wherein the builder module is further configured to layout one or more builds including partitions, the partitions including a portion of each of the multiple memory layers.

19. The non-volatile memory compiler of claim 17, wherein the builder module is further configured to provide a dedicated decoder logic for the one or more memory builds including multiple memory layers, the dedicated decoder logic including a dedicated X decoder and a dedicated Y decoder for each of the multiple memory layers of the one or more memory builds including multiple memory layers.

20. The non-volatile memory compiler of claim 17, wherein the builder module is further configured to provide a shared decoder logic for the one or more memory builds including multiple layers, the shared decoder logic including a multiplexer to share a set of Y decoders among the multiple memory layers of the one or more memory builds including multiple memory layers.

21. The non-volatile memory compiler of claim 15, wherein the builder module is further configured to layout one or more memory builds including a logic layer underneath the one or more non-volatile memory arrays.

22. The non-volatile memory compiler of claim 21, wherein the builder module is further configured to layout a plurality of vias to provide electrical communication between the logic layer and the one or more non-volatile memory arrays.

23. The non-volatile memory compiler of claim 15, wherein the non-volatile memory arrays include non-volatile memory cells, each non-volatile memory cell including no more than two terminals.

24. The non-volatile memory compiler of claim 15, wherein the builder module is further configured to layout memory builds including stacked memory arrays.

25. The non-volatile memory compiler of claim 15, wherein the design input includes a memory area, and a capacity and wherein the builder module determines a number of memory array layers in the memory build based on the memory area and the capacity.

26. The non-volatile memory compiler of claim 15, wherein the design inputs include a memory area, a speed, and a capacity, and wherein the builder module determines a number of memory array layers in the memory build based on the memory area, the speed, and the capacity.

27. A non-volatile memory compiler operative to lay out memory cells including no more than two terminals.

28. A non-volatile memory compiler operative to produce a memory design including three-dimensions.

29. A non-volatile memory compiler operative to produce a memory design including multiple layers of memory arrays.

30. The non-volatile memory compiler of claim 29, wherein the memory arrays comprise two-terminal cross-point arrays.

31. A non-volatile memory compiler configured to plane share.

32. A computer readable medium including computer readable instructions for executing programmed steps, comprising:
receiving a plurality of parameters;
electronically compiling a plurality of memory builds based on the plurality of parameters, the memory builds including non-volatile memory; and
providing characteristics for the plurality of memory builds.
